(19) United States
(12) Patent Application Publication
(10) Pub. No.: US 2005/0198883 A1
(43) Pub. Date: Sep. 15, 2005

(54) Point of use multiple part business form with identification article and separable response or remembrance piece

(76) Inventors: James L. Lowry, Fort Scott, KS (US); William R. Russell, Pittsburg, KS (US)

Correspondence Address: WARD KRAFT, INC., P.O. BOX 938, FORT SCOTT, KS, 66701, US

(21) Appl. No.: 10/798,033

(22) Filed: Mar. 11, 2004

(51) Int. Cl. G09F 3/10

(52) U.S. Cl. 40/674

(57) ABSTRACT

The present invention relates to a multipart business form that includes at least one removable and potentially formable identification card, band, tag or badge on one portion of the substrate and at least one separable postcard on the second portion of the multipart business form. The postcard portion can be used as a response piece, request for information or simply as a remembrance piece for an event which triggered the issuance of the identification portion.

### CROSS-REFERENCES TO RELATED APPLICATIONS

None.

### FIELD OF THE INVENTION

The present invention pertains to the field of business forms and information conveying substrates that are used in connection with providing business or personal communications. The business form described herein is suitable for use in identifying participants or members of a group and a includes a separable response or remembrance piece for transmitting additional information or data about the attendee or article. More particularly, the form construction of the present invention is a multiple part configuration in which a first part is used in the identification of an individual, article or item and the second portion of the construction includes a postcard that may be detached in an effort to collect additional information, indicate acceptance or simply to provide a remembrance article commemorating the event.

### BACKGROUND OF THE INVENTION

Business forms are generally known and are commonly used for conveying information relating to a particular product, service, opportunity or other communication regardless of whether the message has commercial or simply personal foundations. Business forms are produced in many different configurations, for many different purposes and have evolved through time due to changes in technology, such as, in recent memory, the shift from impact printers to non-impact printers such as laser printers.

With the increase in the desire to capture as much information about potential consumers as possible, there has been a continuing rise in the need to create various mechanisms by which to obtain data from customers about purchasing habits, future commercial purchases or plans and the like. Such capture devices include traditional surveys and direct mail or response mail applications where a recipient in response to an offer completes a simple questionnaire and returns the form to the sender. However, such applications typically have a fairly low response or return rate, and often the rate of return may only be a single digit percentage when compared with the total number of mailings that were initially sent out to the group of recipients.

Part of the difficulty in such response mail programs is that the recipient receives the piece as part of the regular mail and while the event which triggered the mailing may be relevant to the particular customer, such as a recent purchase or attendance at an event or place, that event is often removed from the time at which the recipient receives the piece and as such there is likely little desire to comment on the event as whatever thoughts the consumer had are now long dissipated and the work required to respond is simply not worth the effort in the eyes of the recipient.

The use of postcards is generally attractive in that postcards can deliver information to intended recipients or serve as response pieces by taking advantage of reduced postal rates, in that the card generally represents only a single ply or thickness thus making them available for the discounted rate. Postcards have been commonly employed in the past and are regularly used to convey billing information to intended recipients such in the case of utility bills, refuse collection or other contracted services to the homeowner or business.

Postcards have also served to deliver notice to recipients about the availability of an order, reminder of appointments and the like. One exemplary postcard construction is provided in U.S. Pat. No. 2,018,984. Other prior art postcard configurations have been used as advertising pieces such as U.S. Pat. No. 2,805,816; incorporated into greeting cards as shown in U.S. Pat. No. 4,070,778; special postal service or return receipt forms such as U.S. Pat. No. 4,368,903; to transmit photographs such as shown by U.S. Pat. No. 4,807,807; to issue rebate checks as is provided in U.S. Pat. No. 5,085,470; pharmaceutical request forms depicted in U.S. Pat. No. 5,181,743; as part of an advertising insert for newspapers or magazines as provided in U.S. Pat. No. 5,340,017; and used as novelties as shown in U.S. Pat. No. 6,336,631.

Identification devices are also generally widely known and have taken the form of identification cards, wristbands, tags, badges, etc. Such articles generally include an individual's name, potentially a photograph and information relating to the event or criteria for which the individual may be admitted to such an event or the like. Exemplary wristband products are shown in U.S. Pat. Nos. ______ and ______. Examples of identification cards are depicted in U.S. Pat. Nos. ______ and ______.

Identification documents are generally issued upon a request or as part of some sort of statutory mandate or requirement. There has also been a rise in the number of identification documents that are issued at the time of entry, participation or when some other immediate or exigent situation arises. Societal changes have also dictated a need for verifying members of a group, participants or the like so that if an individual is lost or worse, some form of identification is available to assist in the tracking or locating of that person.

As such there is a need for a business form that serves the dual purposes of providing an identification medium that can be easily rendered as well as means for communicating either with the sponsor such as through the use of a response or information request card or providing a remembrance of the particular event which triggered the issuance of the identification means.

Publications, patents and patent applications are referred to throughout this disclosure. All references cited herein are hereby incorporated by reference.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The present invention is a novel communication and identification form assembly that can be used to convey information about an event, individual, group, article or item after the identification pieces have been issued to a requestor. The form assembly in its broadest aspects includes at least two parts, one of which is a post card that may serve a number of purposes including response, request for information or remembrance item for the particular event. The other part includes one or more removable or separable identification pieces that can be used to identify a person or other subject that is in the interest of the requestor.

In one exemplary embodiment of the present invention, a multipart business form, is described and includes a substrate having first and second portions, top and bottom edges, first and second side edges and first and second faces. The first portion of the substrate has at least one separable identification piece that is suitable for recording personal or event information and the second portion of the substrate includes at least one postcard that can serve as a response card, information request or remembrance item.

In a further embodiment of the present invention, an event participation form is described and includes a first part that has one or more detachable personal identification pieces for event participants. Each of the pieces, such as wristbands, of the form is provided with information relating to an event and may also be printed with personalized information. A second part of the form assembly described in the present embodiment includes a separable postcard for providing feedback to an event sponsor. Each of the first and second parts of the form assembly is entirely contained within a substrate suitable for processing through a printer.

In a yet still further embodiment of the present invention, an identification and information request form assembly is described and includes an article to be identified and for which additional information is required. In this exemplary embodiment, a substrate is provided and has at least first and second parts. The substrate is selected so that it is suitable for processing through a printer, such as a non-impact printer, e.g. laser or ink jet printer.

In this presently described embodiment, the first part of the substrate is provided with at least one removable identification piece, and the identification piece is provided with information related to the article that is being identified. The second part of the substrate includes at least one removable postcard that is used for requesting information about the article.

A multipart business form described above uses an identification piece that is selected from a group including wristbands, cards, badges, tags and combinations thereof, the size and dimensions of which are suitable for identifying the article, item or individual that is to be identified.

In addition, it should be understood that the identification piece or pieces that may be used in connection with any one or all of the foregoing embodiments is used for identification of subjects, items or articles selected from a group that includes human, animal, horticultural, agricultural, antiquities, art, household and consumer goods, business supplies and equipment and combinations thereof.

In a still further embodiment of the present invention, method of providing identification and a response card is described and includes the steps of initially providing a multiple part form, the form having first and second sections with the first section having at least one removable identification piece and the second section having at least one separable postcard. Then information is collected about an article, individual or event. Next, information about the article, individual or event is printed on at least the identification piece and the form is provided to a requestor. The requestor then removes the identification piece and dispatches the postcard after removal of the postcard from the form.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts one face of the present invention providing a multipart business form in which one part contains identification bands and the second part contains a detachable postcard;

FIG. 1A illustrates a portion of the form assembly of FIG. 1 and depicts the removal of one of the identification bands revealing a lower layer of a pressure sensitive laminate;

FIG. 1B is a cross sectional view of the portion of the business form assembly shown in FIG. 1A showing a pattern of pressure sensitive adhesive between upper and lower layers of the pressure sensitive laminate;

FIG. 1C presents a side cross sectional view of the present invention in which a pressure sensitive laminate is connected to a card stock which will make up the two sections of the form assembly;

FIG. 2 shows the opposite side of the present invention that is depicted in FIG. 1 and provides a postcard having an illustration and instructions for use of the identification bands;

FIG. 3 provides an alternate configuration and shows a two wide postcard arrangement as well as identification pieces, participant badges;

FIG. 3A depicts a side view of the configuration presented in FIG. 3 illustrating that the business form assembly can be constructed from a single ply of material;

FIGS. 4 through 8 provide exemplary applications of use for the present invention; and

FIG. 9 provides a block diagram showing an exemplary method of using the form of the present invention.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

The substrate suitable for forming the business form assembly of the present invention should be capable of receiving indicia that is generated by imaging equipment, particularly non-impact printing equipment such as an ink jet or laser printer. The substrates may be constructed of a cellulosic material or may be selected from a synthetic film or metalized foil. The dimensions of the substrate is generally 8½″ inches by 11 inches, but it should be understood that other dimensions such as 11 inches by 14 inches or 11 inches by 17 inches may be used or any other size that may be accommodated by a printer or imaging device.

The individual postcard of the present invention should have a size or dimension of approximately 4.25″ by 5.5″-6.″ Thus where a single postcard is used in the assembly of the present invention, the postcard would have an adjacent portion of approximately 2.5″ to 3 inches that could be used for example as a receipt portion acknowledging payment for the article or attendance at a particular event. In a two wide configuration, as will be discussed herein, two postcards are provided side by side in a longitudinal configuration which would occupy the entire width of an 8½″ wide sheet or substrate of material.

Material selected for use with the present invention should be printable and capable of being passed through postal sorting equipment. Generally, cellulosic stock is selected and the stock may contain a coating which adds a glossy appearance to the stock. Where cellulosic stock is selected normally a tag or card stock is used ranging from 80 to 120 pound material. The material can be provided in a cut sheet arrangement or may be made available in a continuous format.

It is anticipated that the business form assembly of the present invention can be utilized in a number of applications, such as academic or athletic events where a series of students or attendees may be given a wristband or entrance badge to be displayed prior to gaining access to the event and the postcard could be used to send to an administrative office such as in connection with an academic event to prove that the student attended the event. In a public sporting event, the postcard could be a remembrance item that could be mailed off to a relative, friend or other associate to show the persons were at the particular show.

Another application for the present invention is in connection with veterinary clinics or treatment centers, where the item to be identified is the family pet and the card is used to request information about the treatment, communication satisfaction or dissatisfaction with the services, obtain a prescription or details related to a medication or other useful data, such as communicating a desire for another appointment.

The form assembly of the present invention is also suitable for use with family vacations or group activities. The form could be printed at the time the admission price is paid such as for access to an amusement park, tourist activity, or the like and a series of wristbands, badges, etc. are created for each member of the family or group. Then the family or group member can send off the postcard to a friend or family member to show they were at a particular spot or location. Alternatively, the postcard portion could be used to comment on the admission process, pricing of the tickets, appearance of the park or any other comments that the consumer may have.

A still further use of the present invention would be for tradeshows, where an attendee would receive a wristband or entry badge at the time of reservation and payment of fees to access the show and then can use the postcard to enter a sweepstakes for attendees, request product information from a vendor at the show, such as by indicating a booth or display number, or product name, or generally comment on the show itself and whether the exhibition was a worthwhile endeavor and if a repeat visit would be something contemplated by the attendee.

The present invention also finds application in the area of horticulture and agriculture. In this example, a consumer might purchase a plant for a home garden and use the band to wrap around the plant so that the gardener recalls the name of the plant. The purchaser can then use the postcard portion to send off to the nursery or other location where the plant might have been initially grown to request additional information about care of the plant.

Other uses of the present may also be made such as in the acquisition or investigation of art, antiquities, household and consumer goods, business supplies and equipment and the like. In this example, a consumer or purchaser may purchase a piece of art or an antique attached the identification band or card to the article for insurance purposes and then send the card off to a registry service to indicate the transfer of the ownership to the purchaser.

With respect to consumer goods, business supplies and the like the identification piece can be affixed to the equipment and contain warranty or service information, serial numbers and the like and the postcard dispatched to comment on the article purchased, request consumables, such as in an example where the article purchased is a printer, copier, vacuum or the like and to indicate warranty information.

There are of course many other uses and applications for the business form assembly of the present invention. Generally any use where it is beneficial to have both an identification card, band or badge and a postcard to fill a need or desire for additional information or to express comments, or simply to remember a particular event would find the present construction beneficial in addressing these concerns.

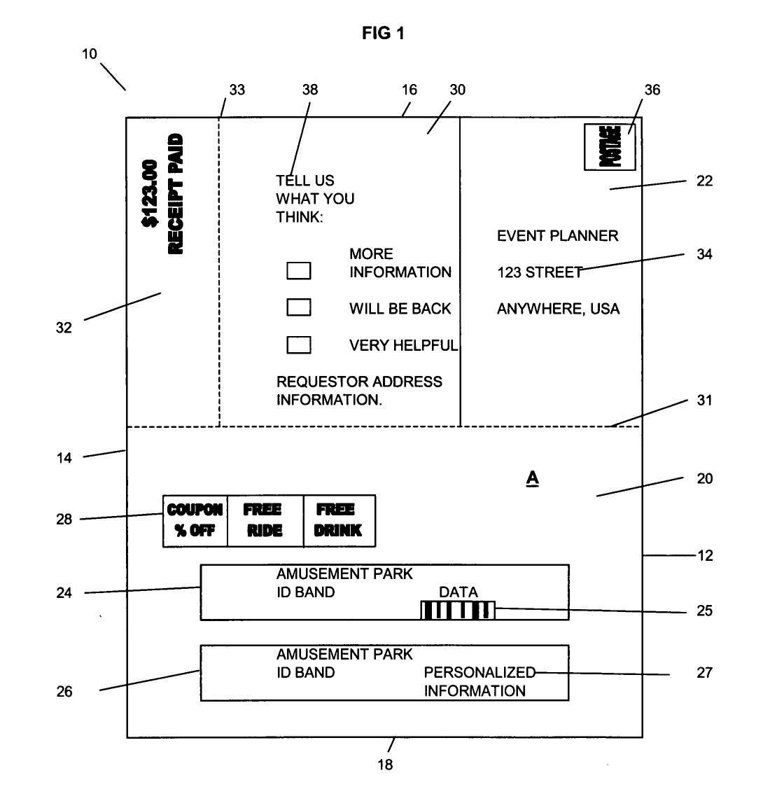

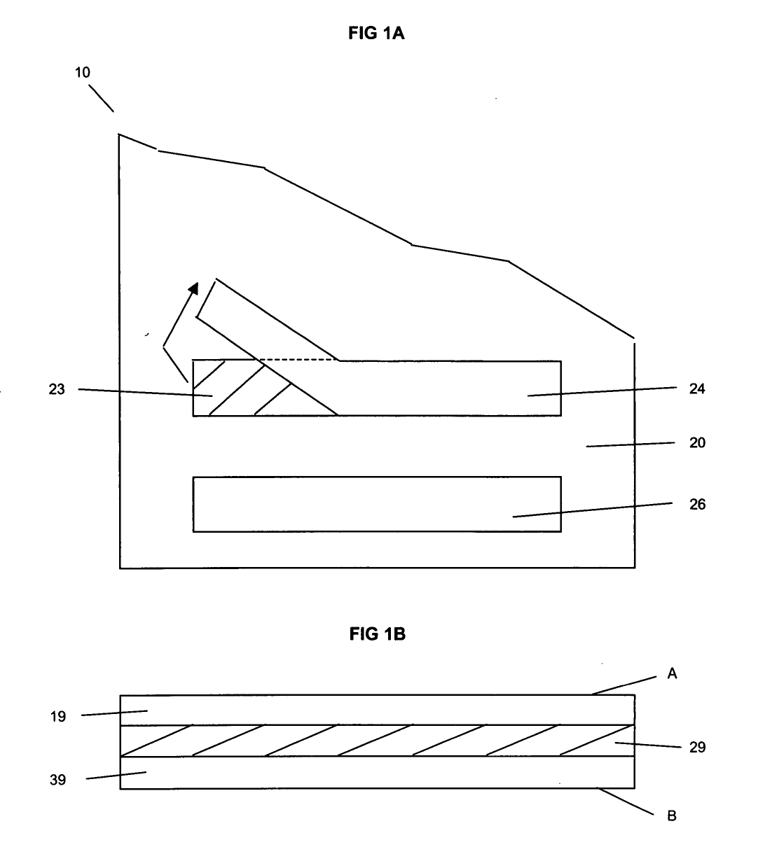

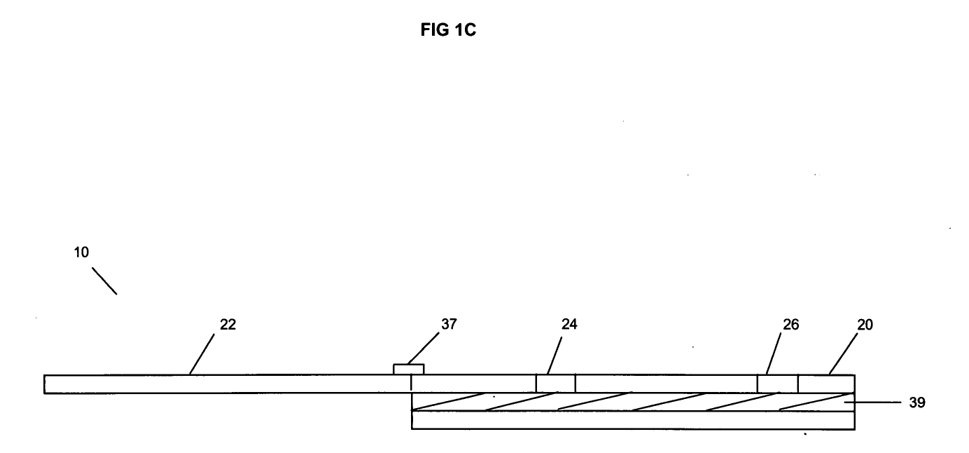

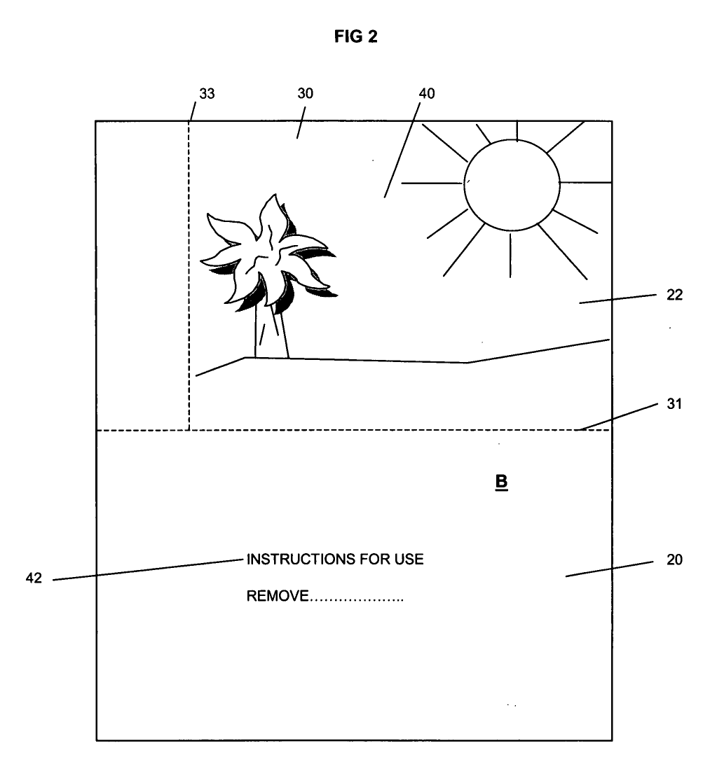

Turning now to FIG. 1 the business form assembly of the present invention is generally depicted by reference to numeral 10. The form has first and second longitudinally extending side edges 12 and 14, top and bottom transversely extending ends 16 and 18 and a first face A and a second face B (shown in FIG. 2). The substrate 10 is divided in to first and second parts 20 and 22, respectively. It should be understood that each part 20 and 22 of the business form assembly 10, may have additional separate parts as will be described herein.

The first portion 12 or the portion containing the identification pieces, here depicted as wristbands 24 and 26 are created from die cutting into a pressure sensitive laminate as will be described herein. The wristbands may be provided with personalized information 25 and 27 which may be made up of alpha, numeric characters or may comprise machine readable indicia such as a bar code. The first part 20 may also include one or more detachable labels 28 which may supplement the offering for which the form is used. Here, the labels 28 are depicted as providing discounts to attractions or other promotions. It should be understood that while the first part 20 depicts only two wristbands 24 and 26, it should be understood that only one may be provided or two or more may be provided depending on the size of the form 10 that is being utilized and whether the form is for an individual participant, couple, family or group of participants. For example, with an 8½″ by 11″ configuration, where only a single postcard is provided there would be available as much as 6¾″ of useable space from which to create a series of removable identification pieces. Obviously, if the form were 8½″ by 14″, more real estate could be provided for identification pieces or alternatively, postcards depending on the needs of the specific application.

The second part 22 of the form assembly 10, as shown in FIG. 1, provides a removable postcard section 30 which is separated from the first section 20 along a line of weakness 31, such as a line of perforations. The second part 22 also includes a receipt or record section 32 which is separable from the postcard section 30 along a vertically extending line of weakness 33, such as a line of perforations. As will be understood, the dimensions of the postcard approximately 4.25″ by 5.5″-6″ when in this configuration, will leave approximately 2.5″ to 3″ of available stock that can be used to reference the transaction and provide a receipt of the value paid for the event.

The postcard 30 is provided with a ship to address at 34, postal indicia or an area to place a stamp 36 as well as a comment section 38 which may include return address information, various boxes to indicate preferences or information needed, comments or any other information or data suitable for the particular application that has been selected by the user of the form assembly 10.

In use, the business form assembly 10 is fed to a printer, such as a non-impact printer and indicia relevant to the transaction is printed out on the form. Personalized information 25 and 27 is applied to the wristbands and return address information may be provided at 38. In addition, the receipt portion 32 is imaged with details relevant to the transaction. The customer or requestor would then remove one or more of the wristbands 24 and 26 and apply the bands to the wrist or other article to be identified. The postcard section 30 is then detached along lines of weakness 31 and 33 and any information that the customer or requestor has been asked to provide is checked off or inserted manually and then the postcard or comment card is deposited in the appropriate receptacle.

Reference is now directed to FIG. 1A, in which the first section 20 of the form assembly 10 is shown in a cut away configuration. The first wristband 24 is shown being removed from the assembly 10 revealing a release coating 23 which has been provided as part of the pressure sensitive laminate to be described herein. FIG. 1A further depicts that only a single wristband may be used, despite the depiction of two wristbands 24 and 26 being provided.

FIG. 1B presents a cross section of the first section or part 20 and further illustrates the pressure sensitive laminate that is use in connection with the present invention. First and second faces A and B are shown. Face A is on layer 19 and face B is layer 39 with a layer of pressure sensitive adhesive 29 disposed there between. As will be understood by those with skill in the art, the pressure sensitive laminate used in the present illustration may be provided with patterns of adhesive and release so that select portions of the laminate will remain together and not separate and other portions of the laminate, such as the wristbands may be readily removed, portions of the individual layers or all of which may contain adhesive to effect the sealing of the band around the wrist or article to which the band has been applied. In addition, uncoated areas may exist to enable the wristband to separate cleanly from the form assembly.

FIG. 1C shows a side, cross section of the business form assembly 10 of the present invention. First and second parts 20 and 22 are provided, and part 20 is shown in an exploded view so as to be able to see the various layers used in making up the pressure sensitive laminate. It should be understood that the thickness of parts 20 and 22 may be identical, roughly identical or have disparate thicknesses, depending on the particular stock selected. For example a 100 pound card stock may have a similar thickness when chosen for part 22 to that of the pressure sensitive laminate of part 20. Alternatively, 20 pound bond paper would likely have a disparate thickness to that of the pressure sensitive laminate.

Where the parts 20 and 22 are not created from a single continuous stock of material, then the parts 20 and 22 may be joined to one another through the use of a strip of tape 37. The tape selected should provide sufficient holding force for the form assembly and be one readily adaptable to being processed through a laser or other printer. In addition, where tape is used to connect the form parts together, the tape 37 would then be perforated so that the portions may be readily separated from one another allowing the postcard to be returned or deposited as is contemplated by the present invention.

FIG. 2 shows the opposite face of that depicted in FIG. 1 and shows the second portion 22 provided with a graphical image 40 on the reverse of the postcard 30. Depiction of an image 40 on the postcard 30 may be provided where the postcard is to be used as a remembrance item, such as one that might be sent to a family member or someone else to demonstrate that the individual was at the particular event or place. It will be understood, where the postcard 30 is simply a response card or request for information that the B side or face (opposite face) of the postcard 30 may be blank, or may be imaged or provided with printed indicia such as other advertising or marketing collateral.

The second part 20 of face B of the assembly 10 may also be used to provide user instructions 42, be blank or may be provided with advertising or marketing collateral, maps to use at the event or such other purposes as may be made of the available “real estate” on the form assembly 10.

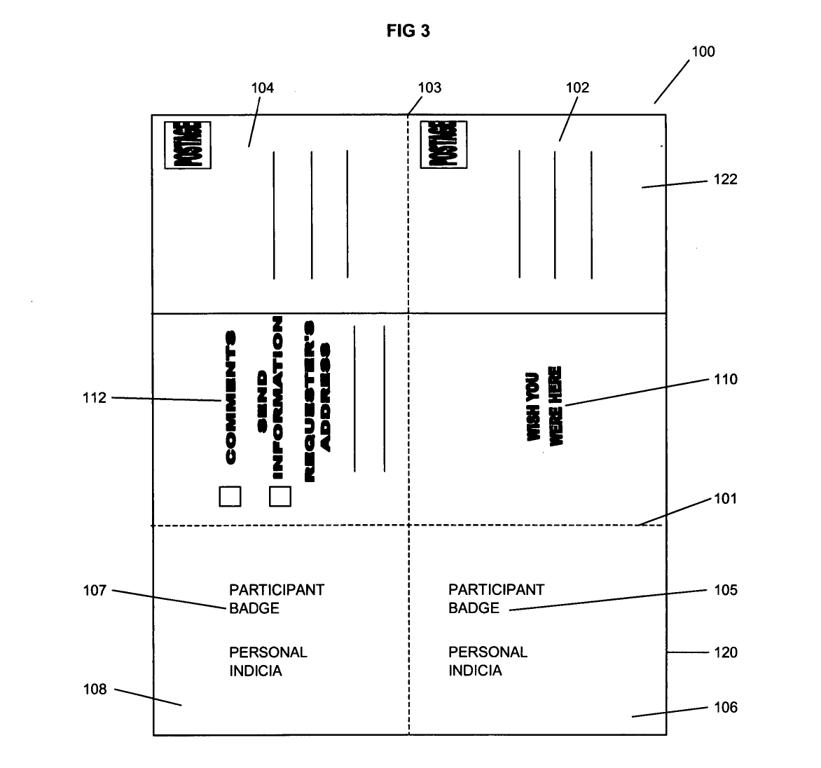

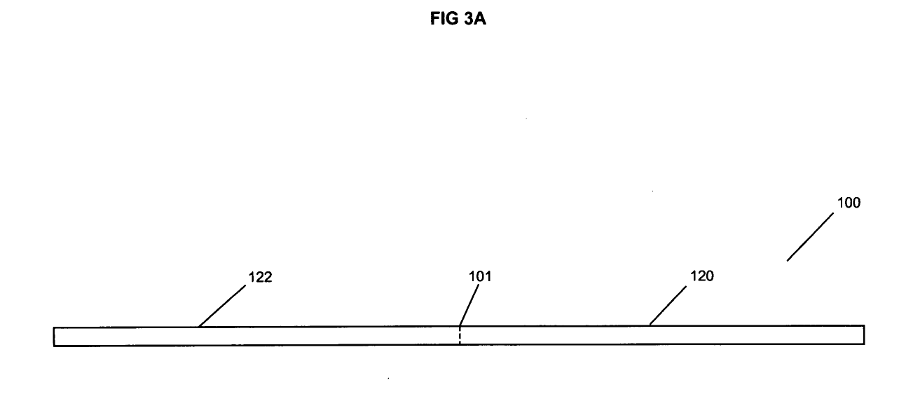

Reference is now directed to FIG. 3 of the present invention in which an alternate configuration is provided. The substrate making up the multiple part business form is depicted by reference to numeral 100. In this embodiment, an 8½″ by 11″ form is depicted in which a pair or postcards 102 and 104 are provided in the second section 122. The postcards 102 and 104 are provided in a longitudinal arrangement so as to maximize the available width of the business form assembly 100. The postcards 102 and 104 have an approximate dimension of 4.25″ by 5.5″-6″ are separable from one another along line of weakness 103 and separable from the identification section of the form assembly along line of weakness 101.

The identification section 120 of the form assembly 100 is provided with two detachable participant badges 106 and 108. Each of the badges 106 and 108 has a dimension of about 5″ by 4.25″. The badges 106 and 108 are each provided with participant information and include personal information or information 105 and 107 that is unique to the event that the individuals are attending.

The postcards 102 and 104 as shown in FIG. 3 are provided for two different end uses, but it should be understood that they could be for identical purposes. As depicted, one postcard 102 is a remembrance piece while postcard 104 is a business communication piece. Postcard 102 is provided with sentiments more akin to personal vacations or sentiments 110 while postcard 104 is printed with business indicia 112 to elicit comments or feedback or to provide a response about the event, product or service that has been utilized.

It will be understood, as was described in connection with FIG. 2, the second face of postcard 102 would be provided with a particular image of a resort, park or some other depiction that would normally be used in conveying greetings to friends, family or other intended recipients. Likewise, the second face of postcard 104 is printed with indicia relevant to the business, service is product for which a response is elicited or alternatively may simply be left blank or unprinted.

FIG. 3A is provided to illustrate that the assembly 100 is constructed in a substantially planar configuration. Sections 120 and 122 are separable from one another along line of weakness 101 and the assembly is formed from a suitable stock of material such as 80 pound tag from which the participant badges and the postcards can be readily separated through the use of lines of weakness as previously depicted in reference to FIG. 3.

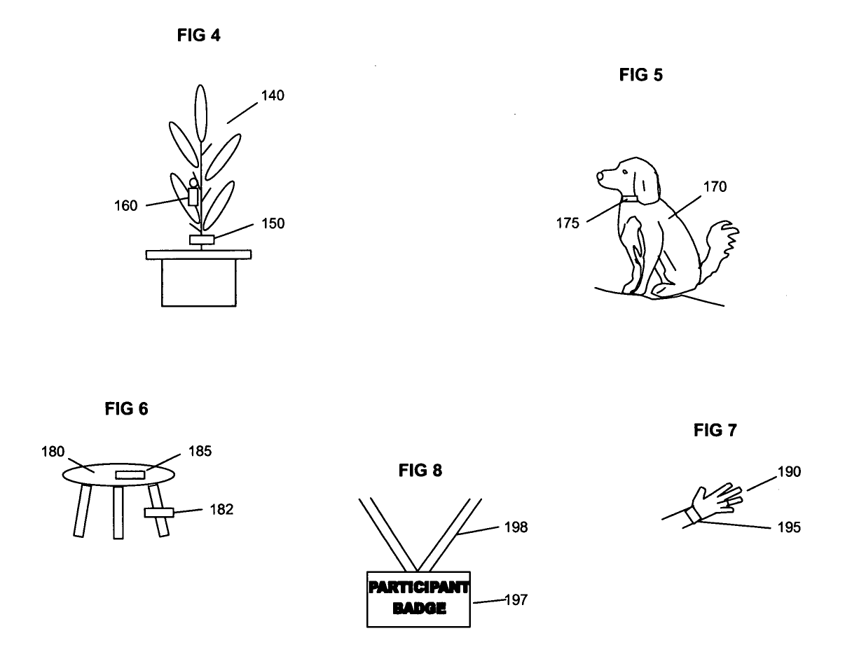

Turning now to FIGS. 4 through 8 of the present specification, a series of potential uses and applications are depicted and it should be understood that the present invention may be utilized in any number of other applications or uses.

FIG. 4 presents a horticultural or agricultural use in which a plant or tree 140 is identified through use of a band 150 or alternatively a tag 160. In this embodiment, the band or tag 160 or 150, respectively, is attached to plant or tree 140 and a postcard, not shown, is completed and mailed off to a nursery or the like requesting care, planting or other instructions. The nursery can then use the information related to the consumer to mail additional information, in addition to the requested information, to the customer to apprise them of other offers that may be of interest to the recipient.

FIG. 5 provides an exemplary use for a veterinary clinic, hospital or the like in which a pet 170 is banded by an identification band 175 and in this situation the pet owner would use the postcard to comment on services, request treatment information for the pet, schedule another appointment or such other uses as may be related to the provisions of veterinarian services.

FIG. 6 is used to illustrate how the present invention might apply to the acquisition of house hold goods, appliances, business supplies or equipment, art antiquities or the like. Here a stool 180 is provided with a band 182 and a card or tag 185 which is used to confirm ownership of the article. Again, the postcard on the form from which the band or card is detached may be mailed off to request information about the article purchased, to be used to notify the vendor of its desire to learn of additional availabilities of similar products or services and such other uses as may be commonly made in such an application.

FIG. 7 shows a still further application of the present invention where a band 195 is connected to the wrist of an arm/hand 190. In this application, the identification piece may be used to identify family members, group participants, etc. to gain entry to a particular event or to participate in a specific exercise or other activity. The postcard portion may be a remembrance piece or may be used to comment or provided information or feedback related to the event so that the sponsor has an idea of what appeals to potential customers.

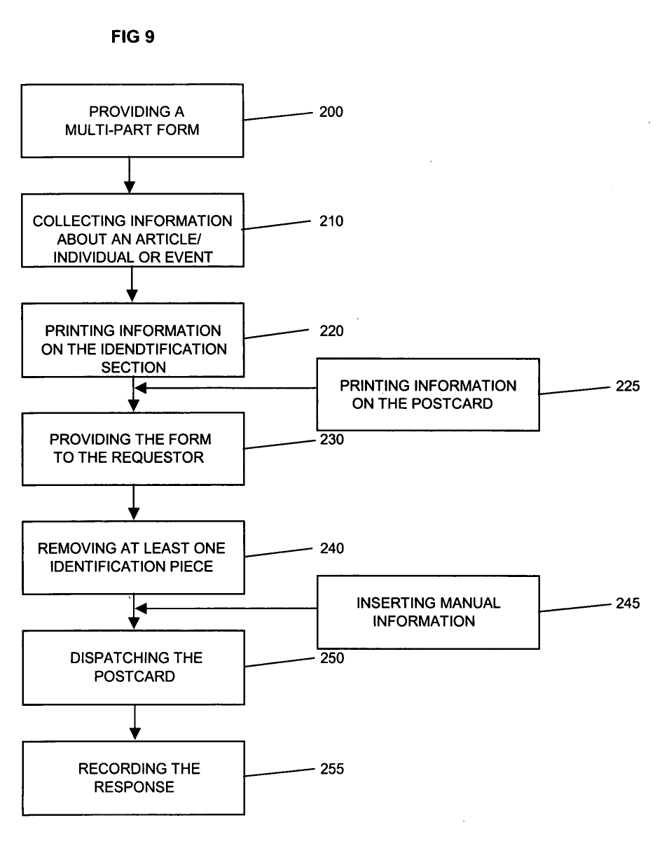

A yet still further embodiment of the present invention includes the use of the invention as a participant badge as depicted in FIG. 8. Here the badge 197 is printed with information related to the attendee and the badge may then be attached to a lanyard 198 or other device, such as a pin or clip to connect the badge to the individual participant so that proof of an individual's registration is readily available. At such trade show applications, the postcard may be used to request information from vendors at the show such as by inserting booth numbers or vendor names or by commenting on the show itself and the likelihood of whether the attendee would be interested in registering for another show.

Turning finally to FIG. 9, a block diagram is provided to illustrate an exemplary use of the multiple part form of the present invention. Initially, a business form as described herein is provided at step 200. The configuration of the form is dependent upon the particular circumstances. For example, if a family of six shows up at an amusement park, the entry clerk may select a family or group form that may have dimensions of 8½ by 11″ so that a greater number of wristbands can be produced for the family or group. This may avoid the necessity of using several 8½″ by 11″ forms if such larger formats are available.

Next and still relying on the example of a family at an amusement park, the entry clerk collects information about the attendees at step 210. That information, which is personal and unique to the family, such as names, gender, level of ride access, food privileges, etc. is then printed on at least the identification bands. The personalized information may be in addition to other pre-existing or static information relating to the park itself. In addition, the entry clerk can at that time print information on the postcard portion at step 225, such that when the family dispatches the postcard, where the card is a comment card or information request card, the park may have the address of the family printed so that the park will know where to send the requested information or make other offers available to the family.

Next, after payment for the entry, the form is provided to the requestor at step 230. The requestor would then remove the individual bands at step 240 and connect the bands to each member of the family prior to entering the park. The requestor, after receiving the form from the entry clerk may manually enter other information at step 245. Such manually entered information may include checking off boxes for future offers, writing comments about the entry process, price of admission, etc. The requestor of the form removes the card from the rest of the form and dispatches the card such as through the mail.

The sponsor of the activity or event, or in the present example, park owner, may then collect all the responses and comments that have been received and record the information at step 255 for later use, such as additional promotional mailings and offers that may be of interest to the customers of the park.

It will thus be seen according to the present invention a highly advantageous multiple part business form that provides an identification means as well as a response, request or remembrance piece has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A multipart business form, comprising;
a substrate having first and second portions, top and bottom edges, first and second side edges and first and second faces;
said first portion of said substrate having at least one separable identification piece suitable for recording personal or event information; and
said second portion including at least one postcard.

2. A multipart business form as recited in claim 1, wherein said identification piece is selected from a group including wristbands, cards, badges, tags and combinations thereof.

3. A multipart business form as recited in claim 1, wherein said first portion includes a pressure sensitive laminate.

4. A multipart business form as recited in claim 3, wherein said identification piece is created from a die cut in said pressure sensitive laminate.

5. A multipart business form as recited in claim 1, wherein said first and second portions are separated by a line of weakness.

6. A multipart business form as recited in claim 1, wherein said postcard is separable from said second portion by lines of weakness.

7. A multipart business form as recited in claim 1, wherein said second portion includes a receipt portion.

8. A multipart business form as recited in claim 1, wherein said first portion includes one or more removable pressure sensitive labels.

9. A multipart business form as recited in claim 1, wherein said postcard is used as a response card, request for information card, remembrance article or combinations thereof.

10. A multipart business form as recited in claim 1, wherein said identification piece is used for identification of subjects selected from a group including human, animal, horticultural, agricultural, antiquities, art, household and consumer goods, business supplies and equipment and combinations thereof.

11. An event participation form, comprising;
a first part having one or more detachable personal identification pieces for event participants, with each piece provided with information relating to an event;
a second part including a separable postcard for providing feedback to an event sponsor; and
each of said first and second parts are entirely contained within a substrate suitable for processing through a printer.

12. An event participation form as recited in claim 1 1, wherein said event is selected from a trade show, amusement park, academic or athletic outing, musical or theatrical performance, resort and vacation packages and combinations thereof.

13. An event participation form as recited in claim 11, wherein said first part is constructed of a pressure sensitive laminate.

14. An event participation form as recited in claim 11, wherein said identification piece is selected from a group including wristbands, cards, badges, tags and combinations thereof.

15. An identification and information request form assembly, comprising;
an article to be identified and for which additional information is required;
a substrate having at least first and second part, said substrate suitable for processing through a printer;
said first part of said substrate is provided with at least one removable identification piece, with said identification piece provided with information related to said article; and
said second part of said substrate includes at least one removable postcard for requesting information about said article.

16. An identification and information request form assembly as recited in claim 15, wherein said article is selected from a group including animal, agricultural, horticultural, antiquities, art, household and consumer goods, business supplies and equipment and combinations thereof.

17. A method of providing identification and a response card, comprising the steps of;
providing a multiple part form, said form having first and second sections with said first section having at least one removable identification piece and said second section having at least one separable postcard;
collecting information about an article, individual or event;
printing information about said article, individual or event on at least said identification piece;
providing the form to a requestor;
removing said identification piece; and
dispatching the postcard after removal of the postcard from the form.

18. A method as recited in claim 17, including a further step of printing information on the postcard after the step of printing information about said article, individual or event.

19. A method as recited in claim 17, including a further step of inserting information manually after the step of removing the identification piece.

20. A method as recited in claim 17, including a further step of recording responses, comments received from the postcard after the step of dispatching the postcard.
